(19) United States
(12) Patent Application Publication
(10) Pub. No.: US 2025/0079703 A1
(43) Pub. Date: Mar. 6, 2025

(54) ELECTROMAGNETIC WAVE CONTROL ELEMENT AND MANUFACTURING METHOD THEREOF

(71) Applicant: FUJIFILM CORPORATION, Tokyo (JP)

(72) Inventors: Masashi ONO, Kanagawa (JP); Hideki YASUDA, Kanagawa (JP)

(21) Appl. No.: 18/954,551

(22) Filed: Nov. 21, 2024

Related U.S. Application Data
(63) Continuation of application No. PCT/JP2023/018322, filed on May 16, 2023.

(30) Foreign Application Priority Data
May 31, 2022 (JP) 2022-088993

(51) Int. Cl. H01Q 3/44; H01Q 15/14

(52) U.S. Cl. CPC H01Q 3/44; H01Q 15/14

(57) ABSTRACT

Provided are an electromagnetic wave control element including a first patterned conductive layer, an insulating layer, and a layer containing a material of which conductivity changes with a voltage, and a manufacturing method of an electromagnetic wave control element.

### CROSS-REFERENCE TO RELATED APPLICATIONS

This application is a continuation of International Application No. PCT/JP2023/018322, filed on May 16, 2023, which claims priority from Japanese Patent Application No. 2022-088993, filed on May 31, 2022. The entire disclosure of each of the above applications is incorporated herein by reference.

### BACKGROUND OF THE INVENTION

### 1. Field of the Invention

The present disclosure relates to an electromagnetic wave control element and a manufacturing method thereof.

### 2. Description of the Related Art

In recent years, it has been studied to apply an electromagnetic wave control element comprising a substrate and a pattern which is composed of a conductive material or the like and is provided on a surface of the substrate to an optical element for electromagnetic waves having a frequency of 0.1 THz to 10 THz (wavelength: 30 μm to 3,000 μm) (hereinafter, also referred to as electromagnetic waves in a terahertz band).

For example, JP2021-114647A discloses a radio wave reflection device that comprises a metamaterial comprising a metasurface substrate and a pattern of a metal film, provided on a surface of the metasurface substrate, and a dielectric substrate.

### SUMMARY OF THE INVENTION

The metamaterial is required to have various characteristics, and one of the characteristics is that a transmittance of electromagnetic waves can be changed. In the radio wave reflection device of JP2021-114647A, the transmittance of electromagnetic waves in the metamaterial is controlled by changing a distance between the metamaterial and the dielectric substrate.

In a control method of the transmittance of electromagnetic waves, an amount of change in the distance tends to increase depending on a wavelength range of the electromagnetic waves, and there is room for improvement in simplicity of controlling the transmittance of the electromagnetic waves.

An object to be achieved by an embodiment of the present disclosure is to provide an electromagnetic wave control element and a manufacturing method thereof, which can easily control a transmittance at at least some wavelengths of electromagnetic waves by applying a voltage.

Specific units for achieving the object are as follows.
<1> An electromagnetic wave control element comprising: a first patterned conductive layer; an insulating layer; and a layer containing a material of which conductivity changes with a voltage.
<2> The electromagnetic wave control element according to <1>, further comprising: a second patterned conductive layer on a side of the layer containing the material of which the conductivity changes with the voltage, opposite to a side on which the insulating layer is provided.
<3> The electromagnetic wave control element according to <1> or <2>, in which a minimum value of a transmission attenuation rate of the first patterned conductive layer with respect to electromagnetic waves of 0.2 THz to 0.4 THz is −5.0 dB or more.
<4> The electromagnetic wave control element according to any one of <1> to <3>, in which the first patterned conductive layer includes two or more linear structures or linear opening portions.
<5> The electromagnetic wave control element according to <4>, in which a shortest distance between the adjacent linear structures or between the adjacent linear opening portions is 1,000 μm or less.
<6> The electromagnetic wave control element according to any one of <1> to <5>, in which the material of which the conductivity changes with the voltage includes a two-dimensional material.
<7> The electromagnetic wave control element according to <6>, in which the two-dimensional material has carbon.
<8> The electromagnetic wave control element according to any one of <1> to <7>, in which the material of which the conductivity changes with the voltage contains graphene.
<9> The electromagnetic wave control element according to any one of <1> to <8>, in which the material of which the conductivity changes with the voltage includes a material having a band gap of 3.0 eV or more.
<10> The electromagnetic wave control element according to any one of <1> to <9>, in which the material of which the conductivity changes with the voltage includes an oxide semiconductor.
<11> The electromagnetic wave control element according to <10>, in which the oxide semiconductor has at least one of In or Zn.
<12> The electromagnetic wave control element according to any one of <1> to <11>, in which the first patterned conductive layer contains a metal.
<13> The electromagnetic wave control element according to any one of <2> to <11>, in which the second patterned conductive layer contains a metal.
<14> The electromagnetic wave control element according to any one of <1> to <11>, in which the first patterned conductive layer includes a metal wire.
<15> The electromagnetic wave control element according to any one of <2> to <11>, in which the second patterned conductive layer includes a metal wire.
<16> The electromagnetic wave control element according to any one of <1> to <11>, in which the first patterned conductive layer includes an oxide conductor.
<17> The electromagnetic wave control element according to any one of <2> to <11>, in which the second patterned conductive layer includes an oxide conductor.
<18> The electromagnetic wave control element according to any one of <1> to <11>, in which the first patterned conductive layer includes an oxide conductor wire.
<19> The electromagnetic wave control element according to any one of <2> to <11>, in which the second patterned conductive layer includes an oxide conductor wire.
<20> The electromagnetic wave control element according to any one of <1> to <19>, further comprising: a substrate on a side of the first patterned conductive layer opposite to a side on which the insulating layer is provided.
<21> The electromagnetic wave control element according to <20>, in which a dielectric loss tangent of the substrate at a frequency of 28 GHz is 0.05 or less.
<22> The electromagnetic wave control element according to <20> or <21>, in which a transmittance of light having a wavelength of 550 nm of the substrate is 5% or more.
<23> The electromagnetic wave control element according to any one of <20> to <22>, in which the substrate contains an inorganic compound.
<24> The electromagnetic wave control element according to <23>, in which the inorganic compound is one or more compounds selected from the group consisting of glass, ceramic, and silicon.
<25> The electromagnetic wave control element according to any one of <20> to <22>, in which the substrate contains a resin.
<26> The electromagnetic wave control element according to <25>, in which the resin is one or more resins selected from the group consisting of a cycloolefin polymer, polyimide, modified polyimide, a liquid crystal polymer, and a fluoropolymer.
<27> A manufacturing method of an electromagnetic wave control element, the manufacturing method comprising: a step of forming a first patterned conductive layer on a substrate; a step of forming an insulating layer on the first patterned conductive layer; and a step of forming a layer containing a material of which conductivity changes with a voltage on the insulating layer.

According to an embodiment of the present disclosure, it is possible to provide an electromagnetic wave control element and a manufacturing method thereof, which can easily control a transmittance at at least some wavelengths of electromagnetic waves by applying a voltage.

### BRIEF DESCRIPTION OF THE DRAWINGS

FIG. 1 is a top view showing an embodiment of a first patterned conductive layer or a second patterned conductive layer.

FIG. 2 is a top view showing another embodiment of the first patterned conductive layer or the second patterned conductive layer.

FIG. 3 is a top view showing still another embodiment of the first patterned conductive layer or the second patterned conductive layer.

FIG. 4 is a schematic sectional view showing an embodiment of an electromagnetic wave control element according to the present disclosure.

### DESCRIPTION OF THE PREFERRED EMBODIMENTS

Hereinafter, the present disclosure will be described in detail.

In the present disclosure, a numerical range described using “to” means a range including the numerical values listed before and after “to” as the lower limit value and the upper limit value.

In the numerical range described stepwise in the present disclosure, the upper limit value or the lower limit value described in a certain numerical range may be replaced with the upper limit value or the lower limit value of another numerical range described stepwise. In addition, regarding a numerical range described in the present specification, the upper limit value or the lower limit value described in a certain numerical range may be replaced with a value described in Examples.

In the present disclosure, the term “layer” or “film” is defined to include not only a case where the layer or film is formed in the entire region but also a case where the layer or film is formed only in a part of the region, upon observing a region in which the layer or film is present.

In the present disclosure, the term “step” includes not only an independent step but also a step that cannot be clearly distinguished from other steps, as long as the intended purpose of the step is achieved.

In the present disclosure, the term “material of which the conductivity changes with the voltage” means a material of which the conductivity changes depending on the presence or absence of the application of a voltage, the magnitude of the applied voltage, and the like.

In the present disclosure, the term “two-dimensional material” refers to a material having a quantum confinement effect in a one-dimensional direction and having electrical conductivity in a two-dimensional direction.

In the present disclosure, the term “oxide conductor” means a material having oxygen in constituent elements and having metallic electrical conductivity.

In the present disclosure, in a case where an embodiment is described with reference to the accompanying drawings, the configuration of the embodiment is not limited to the configuration shown in the drawings. In addition, the sizes of the members in each drawing are conceptual, and the relative size relationships between the members are not limited thereto.

### [Electromagnetic Wave Control Element]

An electromagnetic wave control element of the present disclosure comprises a first patterned conductive layer, an insulating layer, and a layer containing a material of which conductivity changes with a voltage.

The electromagnetic wave control element of the present disclosure can easily control a transmittance at at least some wavelengths of electromagnetic waves by applying a voltage. The mechanism by which the above-described effect is exhibited is not clear, but is presumed as follows.

The electromagnetic wave control element of the present disclosure comprises a layer (hereinafter, also referred to as a “conductivity change layer”) containing a material of which the conductivity changes with a voltage, and can change the transmittance of the conductivity change layer at at least some wavelengths of electromagnetic waves by applying a voltage to the conductivity change layer. In addition, since the first patterned conductive layer included in the electromagnetic wave control element of the present disclosure is formed in a patterned manner, the electromagnetic waves transmitted through the conductivity change layer can be transmitted through the first patterned conductive layer.

In the electromagnetic wave control element of the present disclosure, by applying a voltage to the conductivity change layer, the reflectivity, the transmission phase, and the reflection phase of the conductivity change layer at at least some wavelengths of electromagnetic waves can be easily controlled by the same principle.

In addition, in the electromagnetic wave control element of the present disclosure, the transmission direction and the reflection direction of the conductivity change layer at at least some wavelengths of the electromagnetic waves can be easily controlled by changing the voltage applied to the conductivity change layer in the plane of the insulating layer. The mechanism by which the above-described effect is exhibited is not clear, but it is presumed that, by changing the transmittance, the reflectivity, the transmission phase, and the reflection phase of the conductivity change layer by changing the voltage applied to the conductivity change layer in the plane of the insulating layer, an amplitude type diffraction grating is formed in the plane of the conductivity change layer, and the transmission direction and the reflection direction can be controlled.

The electromagnetic wave control element of the present disclosure can further comprise a second patterned conductive layer on a side of the conductivity change layer opposite to a side on which the insulating layer is provided.

The electromagnetic wave control element of the present disclosure can further comprise a substrate on a side of the first patterned conductive layer opposite to a side on which the insulating layer is provided.

The electromagnetic wave control element of the present disclosure can further comprise an electrode for application that is in contact with at least the conductivity change layer.

### (First Patterned Conductive Layer)

The first patterned conductive layer can include a metal or an oxide conductor.

From the viewpoint of electromagnetic wave transmittance, it is preferable that the first patterned conductive layer contains a metal. From the viewpoint of electromagnetic wave transmittance, the first patterned conductive layer preferably contains one or more selected from the group consisting of gold, silver, platinum, copper, and aluminum.

The shape of the metal is not particularly limited and may be a particle shape or a non-particle shape.

The first patterned conductive layer preferably includes a metal wire containing the above-described metal. Examples of the first patterned conductive layer including a metal wire include a first patterned conductive layer including one or more linear structures containing a metal, or the like. The linear structure will be described later.

A content of the metal with respect to the total mass of the first patterned conductive layer is not particularly limited, and may be 80% by mass or more, 90% by mass or more, or 100% by mass.

Examples of the oxide conductor include oxides containing In, Zn, Sn, Cd, and the like. More specific examples thereof include In₂O₃, ZnO, SnO₂, CdO, a solid solution of these, and those containing a dopant. More specific examples thereof include InSnO, InZnO, Al-doped ZnO, Ga-doped ZnO, F-doped SnO, and antimony-doped SnO.

The first patterned conductive layer preferably includes an oxide conductor wire including the above-described oxide conductor. Examples of the first patterned conductive layer including an oxide conductor wire include a first patterned conductive layer including one or more linear structures including an oxide conductor, or the like.

In addition, the first patterned conductive layer may contain a conductive carbon material such as carbon nanotube or multilayer graphene.

The first patterned conductive layer may be a single layer or a multilayer.

The first patterned conductive layer can include one or more structures or opening portions. The first patterned conductive layer may include two or more structures or opening portions having different shapes, sizes, and the like.

The shape of the structure or the opening portion is not particularly limited, and examples thereof include a C-shape, a U-shape, a double ring shape, a V-shape, an L-shape, a lattice shape, a spiral shape, a linear shape, a rectangular shape, a circular shape, and a cross shape in an in-plane direction of the insulating layer.

A size of the structure or the opening portion is not particularly limited, but it is preferable that the maximum length of the structure or the opening portion is equal to or less than a wavelength size of the incident electromagnetic wave.

In the present disclosure, the maximum length of the structure or the opening portion means a length which is the longest in a case where a straight line is drawn from one end to the other end of the structure or the opening portion in the in-plane direction of the insulating layer.

From the viewpoint of smoothness, a width of the structure or the opening portion is preferably 3 μm to 400 μm. For example, in a case where the structure has a C-shape, the width of the structure refers to a length in a direction orthogonal to a longitudinal direction of the C-shape.

From the viewpoint of increasing the amount of change in the transmittance of the electromagnetic waves with the applied voltage, the first patterned conductive layer preferably includes one or more linear structures (hereinafter, also referred to as “linear structures”) or linear opening portions (hereinafter, also referred to as “linear opening portions”), more preferably includes two or more linear structures or linear opening portions, still more preferably includes three to ten linear structures or linear opening portions, and particularly preferably includes four to eight linear structures or linear opening portions.

In a case where the first patterned conductive layer includes two or more linear structures or linear opening portions, the shortest distance between the adjacent linear structures or between the adjacent linear opening portions is preferably equal to or less than the wavelength size of the incident electromagnetic wave, more preferably 1,000 μm or less, and still more preferably 400 μm to 800 μm.

The distance between the adjacent linear structures or between the adjacent linear opening portions means a distance at which the adjacent linear structures or linear opening portions are closest to each other in the in-plane direction of the insulating layer. In addition, in a case where the first patterned conductive layer includes three or more linear structures or linear opening portions, distances between the adjacent linear structures or between the adjacent linear opening portions are measured, respectively, and the average value thereof is defined as the distance between the adjacent linear structures or between the adjacent linear opening portions.

From the viewpoint of reducing polarization dependence, the structure or the opening portion preferably has a shape that is symmetrical with respect to any X axis and a Y axis orthogonal to the X axis in the in-plane direction of the insulating layer, and examples thereof include a cross shape, a Jerusalem cross shape, a circular shape, and a square shape.

From the viewpoint of electromagnetic wave transmittance, a minimum value of a transmission attenuation rate of the first patterned conductive layer to electromagnetic waves of 0.2 THz to 0.4 THz is preferably −5.0 dB or more, more preferably −3.0 dB or more, still more preferably −2.5 dB or more, and particularly preferably −1.0 dB or more. The upper limit of the minimum value of the transmission attenuation rate is not particularly limited, but is preferably −0.1 dB or less.

In the present disclosure, the transmittance of the first patterned conductive layer with respect to an electromagnetic wave of 0.3 THz is measured as follows using a time-domain terahertz spectroscopy system using a femtosecond pulse laser.

The first patterned conductive layer is fixed to a sample holder having a diameter of 10 mm, and the transmission amplitude during the vertical incidence is measured. The number NA of the incidence openings of the terahertz beam incident on the first patterned conductive layer is set to ⅙.

The transmission amplitude of the first patterned conductive layer is measured, the transmission attenuation rate of the first patterned conductive layer with respect to the electromagnetic waves of 0.2 THz to 0.4 THz is calculated, and the minimum value thereof is obtained.

In a case where the minimum value of the transmission attenuation rate of the first patterned conductive layer with respect to the electromagnetic waves of 0.2 THz to 0.4 THz cannot be obtained by the above-described method, an image of the shape of the first patterned conductive layer is acquired using an optical microscope, and the electromagnetic wave simulation is performed on the image to obtain the minimum value of the transmission attenuation rate of the first patterned conductive layer with respect to the electromagnetic waves of 0.2 THz to 0.4 THz.

From the viewpoint of electromagnetic wave transmittance, smoothness, and the like, the thickness of the first patterned conductive layer is preferably 10 nm to 1,000 nm, more preferably 30 nm to 300 nm, and still more preferably 50 nm to 200 nm.

In the present disclosure, the thicknesses of the first patterned conductive layer, the second patterned conductive layer, and the like are determined by measuring a cross section of the electromagnetic wave control element in a thickness direction with a scanning electron microscope (SEM) and taking an average value of any five points.

In addition, from the viewpoint of adhesiveness, it is preferable that a metal chromium layer, a metal titanium layer, a metal nickel layer, or the like is provided between the substrate and the first patterned conductive layer.

### (Insulating Layer)

The specific resistance value of the insulating layer is preferably 10⁷ Ωcm or more.

In addition, the specific resistance value of the insulating layer can be obtained by conversion from the volume resistance measurement or the surface resistance measurement using a ring-shaped electrode after removing the conductivity change layer and the second patterned conductive layer in the upper portion of the insulating layer.

From the viewpoint of easily obtaining high insulating properties, the insulating layer preferably contains one or more compounds selected from aluminum oxide (Al₂O₃), SiO₂, SiNₓ, SiON, MgO, Y₂O₃, TiO₂, GeO₂, Ta₂Os, HfO₂, Sc₂O₃, Ga₂O₃, ZrO₂, Ln₂O₃ (oxides of lanthanoids), or the like, or may be a mixture of two or more thereof. In addition, the insulating layer may be a laminated film of two or more thereof.

The content of the compound with respect to the total mass of the insulating layer is preferably 50% by mass or more, more preferably 60% by mass or more, still more preferably 70% by mass or more, particularly preferably 80% by mass or more, and most preferably 90% by mass or more, and it may be 100% by mass.

From the viewpoint of the electromagnetic wave transmittance, the thickness of the insulating layer is preferably in a range of 500 nm to 8,000 nm, more preferably in a range of 1,000 nm to 7,000 nm, and still more preferably in a range of 1,500 nm to 6,000 nm.

### (Conductivity Change Layer)

In the present disclosure, the conductivity change layer means a layer containing a conductivity change material.

The difference between the transmission attenuation rate in a case where a voltage of 100 V is applied to the conductivity change layer and the transmission attenuation rate in a case where no voltage is applied is preferably 5 dB or more and more preferably 10 dB or more.

The transmission attenuation rate of the conductivity change layer is calculated based on a transmission amplitude measured using a time-domain terahertz spectroscopy system using a femtosecond pulse laser.

It is preferable that the material of which the conductivity changes with the voltage (hereinafter, also referred to as a “conductivity change material”) includes a two-dimensional material.

From the viewpoint of increasing the amount of change in transmittance of electromagnetic waves due to the applied voltage, it is preferable that the two-dimensional material has carbon. Examples of the two-dimensional material include graphene, a layered crystal of P, As, Sb, or Bi, a transition metal dichalcogenide represented by h-BN, AB₂ (A; Ti, Zr, Hf, V, Nb, Ta, Mo, W, or the like, B; O, S, Se, or Te), a group 13 chalcogenide such as GaS, GaSe, GaTe, or InSe, a group 14 chalcogenide such as GeS, SnS₂, SnSe₂, or PbO, a bismuth chalcogenide such as Bi₂Se₃ or Bi₂Te₃, a divalent metal hydroxide such as M(OH)₂ (M; Mg, Ca, Mn, Fe, Co, Ni, Cu, or Cd), a metal halide such as MgBr₂, CdCl₂, CdI₂, Ag₂F, AsI₃, or AlCl₃, and a perovskite-based nanosheet.

From the viewpoint of increasing the amount of change in transmittance of electromagnetic waves due to the applied voltage, it is preferable that the conductivity change material contains graphene. From the viewpoint of reducing the loss of radio waves, the mobility of graphene is preferably 1,000 cm²/Vs or more, more preferably 2,000 cm²/Vs or more, and particularly preferably 3,000 cm²/Vs or more. The upper limit value of the mobility of graphene is not particularly limited.

From the viewpoint of increasing the amount of change in transmittance of electromagnetic waves due to the applied voltage, it is preferable that the conductivity change material includes an oxide semiconductor.

From the viewpoint of increasing the amount of change in transmittance of electromagnetic waves due to the applied voltage, it is preferable that the oxide semiconductor has at least one of indium (In) or zinc (Zn).

Examples of the oxide semiconductor include indium oxide (In₂O₃), In—Ga—Zn—O (IGZO), In—Zn—O (IZO), In—Ga—O (IGO), In—Sn—O (ITO), In—Sn—Zn—O (ITZO), a mixture of these compounds, and a compound obtained by adding a dopant to these compounds.

From the viewpoint of increasing the amount of change in transmittance of electromagnetic waves due to the applied voltage, it is preferable that the conductivity change material includes a material having a band gap of 3.0 eV or more.

Examples of the material having a band gap of 3.0 eV or more include the above-described oxide semiconductor.

In the present disclosure, the band gap is measured as follows.

Using an ultraviolet-visible-near infrared spectrophotometer, the absorbance of the conductivity change material in a wavelength range of 300 nm to 1100 nm is measured.

The absorbance measured by the above-described method is plotted on a graph in which the vertical axis represents (ahv)^{R} and the horizontal axis represents the energy value (eV), and converted into an (ahv)^{R}-eV curve. Here, the coefficient R is R=½ in a case of a direct allowed transition, R=3/2 in a case of a direct forbidden transition, R=2 in a case of an indirect allowed transition, and R=3 in a case of an indirect forbidden transition. The (ahv)^{R}-eV curve is a graph in which a vertical axis represents (ahv)^{R} and a horizontal axis represents an energy value (eV). a is an absorbance, h is a Planck constant, and v is a vibration frequency.

As the ultraviolet-visible-near infrared spectrophotometer, U-4150 manufactured by Hitachi High-Tech Corporation or a device equivalent to U-4150 can be used.

The energy value E¹ at the wavelength λ¹ has the following relationship. The wavelength can be converted into an energy value from the following relational expression.

E¹=1240/λ¹

The unit of E¹ is eV, and the unit of λ¹ is nm.

In the (ahv)^{R}-eV curve, an energy value at an intersection between a tangent line at a portion where the value of (ahv)^{R} rises and a tangent line at a portion before the value of (ahv)^{R} rises is calculated, and the energy value at the intersection is defined as the band gap energy.

From the viewpoint of increasing the amount of change in transmittance of electromagnetic waves due to the applied voltage, the content of the conductivity change material with respect to the total mass of the conductivity change layer is preferably 50% by mass or more, more preferably 60% by mass or more, still more preferably 70% by mass or more, particularly preferably 80% by mass or more, and most preferably 90% by mass or more, and it may be 100% by mass.

In a case where the conductivity change material contains graphene, from the viewpoint of increasing the amount of change in transmittance of electromagnetic waves due to the applied voltage, the content of the graphene with respect to the total mass of the conductivity change material is preferably 50% by mass or more, more preferably 60% by mass or more, still more preferably 70% by mass or more, particularly preferably 80% by mass or more, and most preferably 90% by mass or more, and it may be 100% by mass.

In a case where the conductivity change material includes an oxide semiconductor, from the viewpoint of increasing the amount of change in transmittance of electromagnetic waves due to the applied voltage, the content of the oxide semiconductor with respect to the total mass of the conductivity change material is preferably 50% by mass or more, more preferably 60% by mass or more, still more preferably 70% by mass or more, particularly preferably 80% by mass or more, and most preferably 90% by mass or more, and it may be 100% by mass.

From the viewpoint of the electromagnetic wave transmittance, the thickness of the conductivity change layer is preferably in a range of 0.1 nm to 1 μm, more preferably in a range of 0.1 nm to 300 nm, and still more preferably in a range of 0.1 nm to 150 nm.

### (Second Patterned Conductive Layer)

The second patterned conductive layer preferably serves as a resonator for electromagnetic waves.

The second patterned conductive layer can include a metal or an oxide conductor. Since the metal and the oxide conductor have been described above, the description thereof will not be repeated here.

In addition, the second patterned conductive layer may include a metal wire or an oxide conductor wire.

In addition, the second patterned conductive layer may contain a conductive carbon material such as carbon nanotube or multilayer graphene.

The second patterned conductive layer may be a single layer or a multilayer.

The second patterned conductive layer can include one or more structures or opening portions. The second patterned conductive layer may include two or more structures or opening portions having different shapes, sizes, and the like.

A shape of the structure or the opening portion is not particularly limited, but is preferably a shape capable of inducing a dielectric or magnetic response change by generating a charge bias, a current, or the like in the structure, in the opening portion, between adjacent structures, between adjacent opening portions, or the like due to an interaction between the electric field, the magnetic field, or the like of an electromagnetic wave in a terahertz band, which is incident on the electromagnetic wave control element.

The shape of the structure or the opening portion is not particularly limited, and examples thereof include a C-shape, a U-shape, a double ring shape, a V-shape, an L-shape, a lattice shape, a spiral shape, a linear shape, a rectangular shape, a circular shape, and a cross shape in an in-plane direction of the insulating layer.

From the viewpoint of increasing the amount of change in transmittance of electromagnetic waves due to the applied voltage, it is preferable that the second patterned conductive layer includes an opening portion having the above-described shape.

The size of the structure of the opening portion is not particularly limited, and the maximum length of the structure or the opening portion is preferably equal to or less than the wavelength size of the incident electromagnetic wave, more preferably 1,000 μm or less, and still more preferably 10 μm to 800 μm.

From the viewpoint of smoothness, a width of the structure or the opening portion is preferably 3 μm to 400 μm.

In a case where the structure or the opening portion is a split-ring resonator, from the viewpoint of smoothness of the pattern, the gap is preferably 1 μm to 15 μm.

The split-ring resonator means a structure or an opening portion having a C-shape or a U-shape.

A disposition position of the structure or the opening portion is not particularly limited, and is preferably a disposition in which the structure or the opening portion resonates with the electromagnetic wave in the terahertz band.

In addition, the structure or opening portion may be disposed on the surface of the substrate, in which a periodic structure is formed such that the amount of phase shift of the electromagnetic wave in the terahertz band is continuously increased or decreased as the region goes from the center of the surface of the insulating layer to the outer side. Examples of one embodiment of the above-described periodic structure include a structure in which structures having different diameters are arranged in a concentric circle. A change width of the diameter of the structures arranged in a concentric circle can be set to 10 μm to 200 μm.

From the viewpoint of electromagnetic wave transmittance, smoothness, and the like, the thickness of the second patterned conductive layer is preferably 30 nm to 300 nm, and more preferably 50 nm to 200 nm.

### (Substrate)

The substrate used in the present disclosure is not particularly limited, and a substrate made of a known material can be used.

The shape, structure, size, and the like of the substrate are not particularly limited, and the substrate can be appropriately selected according to the intended purpose. The structure of the substrate may be a monolayer structure or a laminated structure.

The substrate may contain an inorganic compound or may contain a resin.

As the resin, a substrate consisting of a synthetic resin such as polybutylene terephthalate, polyethylene terephthalate, polyethylene naphthalate, polybutylene naphthalate, polystyrene, polycarbonate, polysulfone, polyether sulfone, polyarylate, allyl diglycol carbonate, polyamide, polyimide, modified polyimide, polyamide imide, polyether imide, polybenzazole, polyphenylene sulfide, polycycloolefin, a norbornene resin, a fluoropolymer such as polychlorotrifluoroethylene, a liquid crystal polymer, an acrylic resin, an epoxy resin, a silicone resin, an ionomer resin, a cyanate resin, a crosslinked fumaric acid diester, cyclic polyolefin, an aromatic ether, maleimide-olefin, cellulose, or an episulfide compound, a substrate consisting of a composite plastic material of the above-described synthetic resin or the like and silicon oxide particles, a substrate consisting of a composite plastic material of the above-described synthetic resin or the like and metal nanoparticles, inorganic oxide nanoparticles, inorganic nitride nanoparticles, or the like, a substrate consisting of a composite plastic material of the above-described synthetic resin or the like and carbon fibers or carbon nanotubes, a substrate consisting of a composite plastic material of the above-described synthetic resin or the like and glass flakes, glass fibers, or glass beads, a substrate consisting of a composite plastic material of the above-described synthetic resin or the like and clay minerals or particles having a mica-derived crystal structure, a laminated plastic substrate having at least one bonding interface between thin glass and any of the above-described resins, a substrate consisting of a composite material having barrier properties and at least one or more bonding interfaces by alternately laminating an inorganic layer and an organic layer (a layer containing the above-described synthetic resin), a stainless steel substrate or a metal multilayer substrate obtained by laminating stainless steel and a different metal, an aluminum substrate or an aluminum substrate having an oxide film obtained by performing an oxidation treatment (for example, an anodization treatment) on the surface to improve the insulating properties of the surface, and the like can be used.

Among these, from the viewpoint of dielectric loss tangent, adhesiveness with a pattern, heat resistance, and the like, the resin is preferably one or more resins selected from the group consisting of a cycloolefin polymer, polyimide, modified polyimide, a liquid crystal polymer, and a fluoropolymer.

From the viewpoint of strength, heat resistance, and the like, the inorganic compound is preferably one or more compounds selected from the group consisting of glass, ceramic, and silicon, and from the viewpoint of transmittance in a radio wave region, the inorganic compound is more preferably one or more compounds selected from the group consisting of glass and silicon.

From the viewpoint of increasing the amount of change in transmittance of electromagnetic waves due to the applied voltage, the dielectric loss tangent of the above-described substrate at a frequency of 28 GHz is preferably 0.05 or less, more preferably 0.01 or less, still more preferably 0.005 or less, and particularly preferably 0.001 or less.

The dielectric loss tangent of the substrate can be adjusted by changing a material to be contained in the substrate, or the like.

In the present disclosure, the dielectric loss tangent of the substrate is measured by the following terahertz time-domain spectroscopy (THz-TDS).

First, the substrate is cut into a test piece having a size of 100 mm×100 mm.

Next, an optical system for transmission-type terahertz spectroscopy is produced, and a dielectric loss tangent (frequency: 0.3 THz) of the test piece is measured from a change in time waveform of the optical electric-field before and after insertion of the test piece in an environment of a temperature of 25° C. and a humidity of 10% RH.

In a case where the pattern described later is formed on the surface of the substrate, the above-described measurement of the dielectric loss tangent is carried out using a substrate etched with a solution such as iron chloride.

From the viewpoint of increasing the amount of change in transmittance of electromagnetic waves due to the applied voltage, a transmittance of light at a wavelength of 550 nm of the above-described substrate is preferably 5% or more, more preferably 10% or more, still more preferably 30% or more, and particularly preferably 50% to 100%.

In the present disclosure, the transmittance of light at a wavelength of 550 nm of the substrate is measured as follows.

The transmittance of light at a wavelength of 550 nm of the substrate is measured using a spectrophotometer (for example, UV-2450, manufactured by Shimadzu Corporation).

A thickness of the substrate is not particularly limited, and from the viewpoint of handleability, it is preferably 30 μm to 200 mm, more preferably 40 μm to 100 mm, and still more preferably 50 μm to 50 mm.

As the substrate, a substrate which is produced by a known method in the related art may be used, or a commercially available substrate may be used.

In addition, as the substrate, a woven fabric such as a glass cloth, a nonwoven fabric, or the like may be used by being infused with the above-described resin. Furthermore, a multilayer structure in which a layer is formed on at least one surface of the glass cloth or the like, infused with the above-described resin, using the above-described material such as the resin may be used as the substrate.

### (Electrode for Application)

In order to apply a voltage to the electromagnetic wave control element of the present disclosure, the electromagnetic wave control element can further comprise an electrode for application that is in contact with at least the conductivity change layer. The electrode for application is not particularly limited, and a known electrode in the related art can be used. In addition, the second patterned conductive layer in contact with the conductivity change layer can be used as the electrode for application as it is.

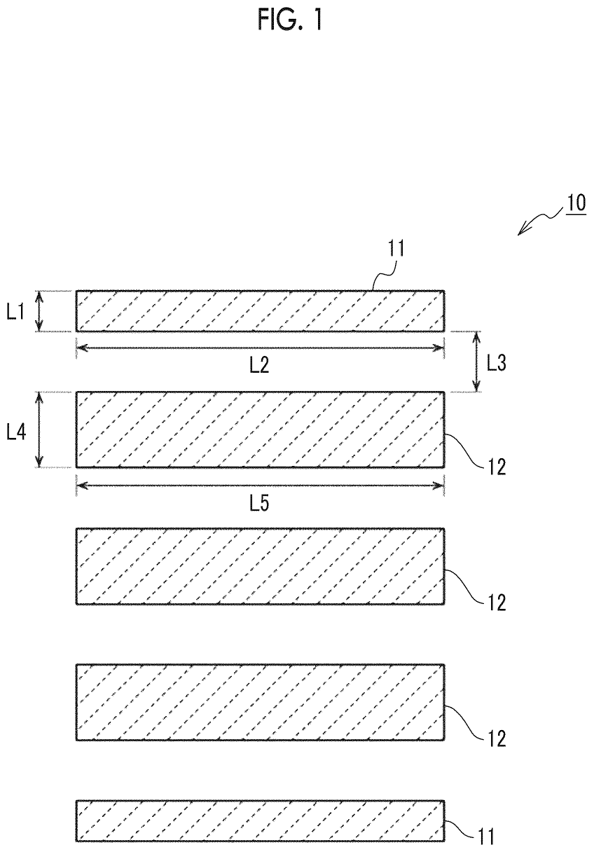

An embodiment of an electromagnetic wave control element of the present disclosure will be described with reference to FIGS. 1 to 4. The electromagnetic wave control element of the present disclosure is not limited thereto.

FIG. 1 shows an embodiment of the first patterned conductive layer or the second patterned conductive layer (hereinafter, also collectively referred to as a “patterned conductive layer”).

A patterned conductive layer 10 shown in FIG. 1 includes a linear structure 11 and a linear structure 12.

A width of the linear structure 11 is denoted by a reference numeral L1, a maximum length of the linear structure 11 is denoted by a reference numeral L2, a width of the linear structure 12 is denoted by a reference numeral L4, a maximum length of the linear structure 12 is denoted by a reference numeral L5, and a shortest distance between the adjacent linear structures 11 or between the adjacent linear structures 12 is denoted by a reference numeral L3.

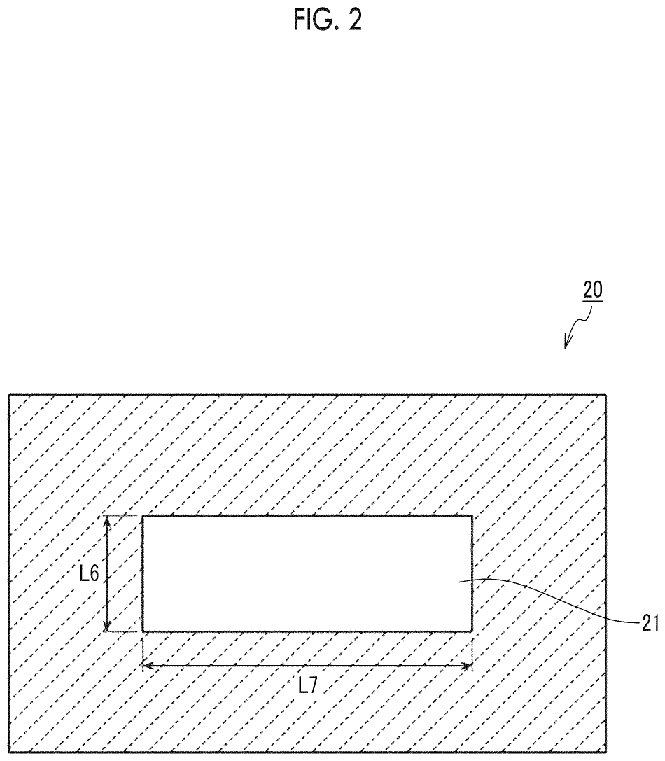

FIG. 2 shows another embodiment of the patterned conductive layer.

A patterned conductive layer 20 shown in FIG. 2 has a pattern including a linear opening portion 21 (a portion surrounded by a line is punched).

A width of the opening portion 21 is denoted by a reference numeral L6, and a maximum length thereof is denoted by a reference numeral L7.

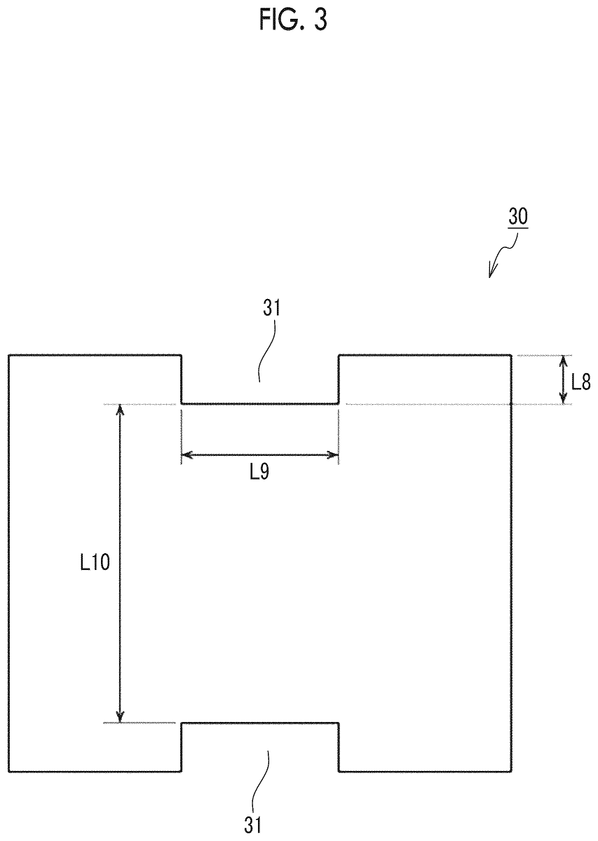

FIG. 3 shows still another embodiment of the patterned conductive layer.

A patterned conductive layer 30 shown in FIG. 3 has a pattern including a linear opening portion 31 (a portion surrounded by a line is punched) at both ends in one direction.

A width of the linear opening portion 31 is denoted by a reference numeral L8, a maximum length thereof is denoted by a reference numeral L9, and a shortest distance between the adjacent linear opening portions 31 is denoted by a reference numeral L10.

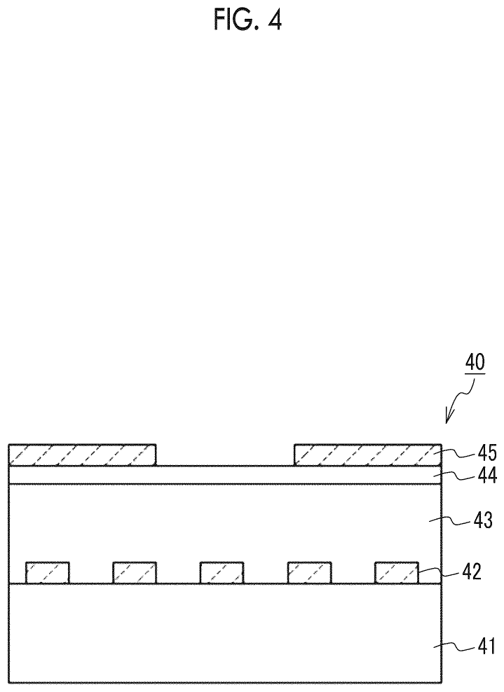

FIG. 4 is a schematic sectional view showing an embodiment of an electromagnetic wave control element 40 according to the present disclosure.

The electromagnetic wave control element 40 shown in FIG. 4 comprises a substrate 41, a first patterned conductive layer 42, an insulating layer 43, a conductivity change layer 44, and a second patterned conductive layer 45.

In FIG. 4, the insulating layer 43 covers the first patterned conductive layer 42.

### [Manufacturing Method of Electromagnetic Wave Control Element]

A manufacturing method of an electromagnetic wave control element of the present disclosure includes a step of forming a first patterned conductive layer on a substrate, a step of forming an insulating layer on the first patterned conductive layer, and a step of forming a layer containing a material of which conductivity changes with a voltage (hereinafter, also referred to as a “conductivity change layer”) on the insulating layer.

The manufacturing method of an electromagnetic wave control element of the present disclosure may include a step of forming a second patterned conductive layer on the conductivity change layer.

The manufacturing method of an electromagnetic wave control element of the present disclosure may include a step of providing an electrode for application that is in contact with at least the conductivity change layer.

Preferred aspects of the substrate, the first patterned conductive layer, the insulating layer, the conductivity change layer, the second patterned conductive layer, and the electrode for application in the manufacturing method of an electromagnetic wave control element of the present disclosure are the same as the preferred aspects of the substrate, the first patterned conductive layer, the insulating layer, the conductivity change layer, the second patterned conductive layer, and the electrode for application in the electromagnetic wave control element according to the present disclosure described above.

### (Step of Forming First Patterned Conductive Layer)

The method of forming the first patterned conductive layer is not particularly limited, and examples thereof include a method of performing punching on a conductive film after being provided on a substrate, a method of forming a sputtered film on a surface of a substrate by using a sputtering method, forming a resist pattern on a surface of the sputtered film, etching and removing the sputtered film not covered with the resist pattern, and then removing the resist pattern to form the first patterned conductive layer, a lift-off method of forming a conductive film by using a sputtering method or the like after forming a resist pattern on the surface of the substrate and removing unnecessary portions of the resist pattern, and a sputtering film forming method through a metal mask.

The method of forming the first patterned conductive layer is not limited to the above-described method, and the first patterned conductive layer may be formed by ink jet, a dispenser, screen printing, pattern plating, or the like instead of the above-described sputtering method, or a vapor-deposited film may be formed by a vapor deposition method instead of the above-described sputtering method.

### (Step of Forming Insulating Layer)

The method of forming the insulating layer is not particularly limited, and the insulating layer can be formed on the first patterned conductive layer by using a sputtering method, a CVD method, an ALD method, thermal oxidation, a sol-gel method, or the like.

### (Step of Forming Conductivity Change Layer)

The method of forming the conductivity change layer is not particularly limited, and for example, in a case where the conductivity change layer is a two-dimensional material, the conductivity change layer can be formed by separately preparing a transfer sheet comprising the two-dimensional material and transferring the conductivity change layer from the transfer sheet onto the insulating layer. In a case where the conductivity change layer is a semiconductor material, the conductivity change layer can be formed using a sputtering method, a vapor deposition method, an MBE method, a CVD method, an ALD method, a PLD method, a sol-gel method, a method of applying and forming a nanoparticle film, or the like.

### (Step of Forming Second Patterned Conductive Layer)

A method of forming the second patterned conductive layer is not particularly limited, and the second patterned conductive layer can be formed by the same method as that for the first patterned conductive layer.

### (Step of Providing Electrode for Application)

The manufacturing method of an electromagnetic wave control element of the present disclosure may include a step of providing an electrode for application that is in contact with at least the conductivity change layer. The electrode for application can be installed by a known method in the related art.

### EXAMPLES

Hereinafter, the above-described embodiment will be specifically described with reference to Examples, but the above-described embodiment is not limited to Examples.

### Example 1

A quartz substrate was prepared as a substrate. The quartz substrate had a dielectric loss tangent of 0.001 at a frequency of 28 GHz, and a transmittance of light having a wavelength of 550 nm was 92%.

An Al vapor-deposited film (conductive film) of 100 nm was formed on the entire surface of the quartz substrate using a vacuum vapor deposition device (EBX-1000) manufactured by ULVAC, Inc.

A resist film was formed on the Al vapor-deposited film, and was exposed and developed by a photolithography method to form a resist pattern.

Next, the region of the Al vapor-deposited film where the resist pattern was not formed was subjected to an etching treatment using mixed acid (mixed acid Al etchant manufactured by Kanto Chemical Co., Inc.) to form a first patterned conductive layer including two kinds of linear structures 11 and 12 (hereinafter, also referred to as “linear structures”) shown in FIG. 1.

In FIG. 1, a portion surrounded by a line indicates a portion in which the Al vapor-deposited film remains.

The linear structures had the same shape, the width L1 of the linear structure 11 was set to 20 μm, the maximum length L2 of the linear structure 11 was set to 270 μm, the width L4 of the linear structure 12 was set to 40 μm, the maximum length L5 of the linear structure 12 was set to 270 μm, and the shortest distance L3 between the adjacent linear structures was set to 40 μm (average value).

The substrate on which the first patterned conductive layer was formed was measured using a time-domain terahertz spectroscopy system using a femtosecond pulse laser.

The substrate was fixed to a sample holder having a diameter of 10 mm, and the transmission amplitude during the vertical incidence was measured. The number NA of the incidence openings of the terahertz beam incident on the first patterned conductive layer on the surface of the substrate was about ⅙.

The transmission amplitude of the first patterned conductive layer was measured, the transmission attenuation rate of the first patterned conductive layer with respect to the electromagnetic waves of 0.2 THz to 0.4 THz was calculated, and the minimum value thereof was obtained. The results are shown in Table 1. The same calculation was performed for the following Examples and Comparative Examples, and the results are shown in Table 1.

An insulating layer (thickness: 5,000 nm) of aluminum oxide (Al₂O₃) was formed on the first patterned conductive layer using a magnetron sputtering device.

A transfer sheet (manufactured by Graphenea S.A.) in which a single-layer graphene was formed on a copper foil by a CVD method was prepared.

Polymethyl methacrylate was spin-coated on a graphene layer of a transfer sheet consisting of the copper foil and the single-layer graphene to form a coating film, and then a thermal tape was attached to the coating film.

The transfer sheet to which the thermal tape was attached was immersed in an iron chloride solution to etch the copper foil, and then washed with pure water to obtain a laminate consisting of a graphene layer, a coating film, and a thermal tape.

The graphene layer of the laminate was attached to the insulating layer, heated at 120° C., and the thermal tape was peeled off.

Next, the coating film of the laminate was removed with acetone to form a conductivity change layer (graphene layer) of one molecular layer (thickness of about 0.3 nm) on the surface of the insulating layer.

A resist film was formed on the conductivity change layer, and was exposed and developed by a photolithography method to form a resist pattern.

Using the vacuum vapor deposition device, a Ti vapor-deposited film of 10 nm and an Al vapor-deposited film of 100 nm were continuously formed on the conductivity change layer on which the resist pattern had been formed.

The resist pattern was removed by a lift-off method using acetone to form the second patterned conductive layer shown in FIG. 2, thereby obtaining an electromagnetic wave control element.

FIG. 2 shows a pattern (a portion surrounded by a line is punched) including the linear opening portion 21 (hereinafter, also referred to as a “linear opening portion”).

The width L6 of the linear opening portion 21 was set to 40 μm, and the maximum length L7 of the linear opening portion 21 was set to 270 μm.

The second patterned conductive layer serves as a resonator for electromagnetic waves.

### Example 2

In the same manner as in Example 1, a quartz substrate was used as a substrate to form an Al vapor-deposited film (conductive film), a resist pattern was formed, and a first patterned conductive layer was formed. Furthermore, in the same manner as in Example 1, an insulating layer (thickness: 5,000 nm) of aluminum oxide (Al₂O₃) was formed on the first patterned conductive layer.

A transfer sheet (manufactured by Institute for 2D Materials LLC.) comprising a sapphire substrate, a copper layer, and a graphene layer was prepared.

Polymethyl methacrylate was spin-coated on a graphene layer of a transfer sheet to form a coating film, and then a thermal tape was attached to the coating film.

The transfer sheet to which the thermal tape was attached was immersed in an iron chloride solution to etch the copper layer, and the sapphire substrate was peeled off. Next, the transfer sheet was washed with pure water to obtain a laminate consisting of a graphene layer, a coating film, and a thermal tape.

The graphene layer of the laminate was attached to the insulating layer, heated at 120° C., and the thermal tape was peeled off.

Next, the coating film of the laminate was removed with acetone to form a conductivity change layer (graphene layer) of one molecular layer (thickness of about 0.3 nm) on the surface of the insulating layer.

Further, in the same manner as in Example 1, a resist film was formed on the conductivity change layer to form a resist pattern.

Further, in the same manner as in Example 1, an Al vapor-deposited film was continuously formed on the conductivity change layer on which the resist pattern was formed, the resist pattern was removed, and the second patterned conductive layer shown in FIG. 2 was formed, thereby obtaining an electromagnetic wave control element.

### Example 3

An electromagnetic wave control element was manufactured in the same manner as in Example 2, except that the first patterned conductive layer was changed to the pattern shown in FIG. 3.

FIG. 3 shows a pattern including the linear opening portion 31 (a portion surrounded by a line is punched) at both ends in a vertical direction.

The width L8 of the linear opening portion 31 was set to 20 μm, the maximum length L9 of the linear opening portion 31 was set to 210 μm, and the shortest distance L10 between the adjacent linear opening portions 31 was set to 250 μm.

### Example 4

An electromagnetic wave control element was manufactured in the same manner as in Example 2, except that the second patterned conductive layer was not provided. Meanwhile, in Example 4, a Ti/Au electrode was formed as an electrode for application at an end part on the graphene layer by using the lift-off method.

### Comparative Example 1

An electromagnetic wave control element was manufactured in the same manner as in Example 3, except that a resist pattern was formed on the Al vapor-deposited film formed on the quartz substrate and the Al vapor-deposited film was not patterned.

### <Measurement of Radio Wave Shielding Performance>

For the dynamic metasurface element (electromagnetic wave control element), a time-domain terahertz spectroscopy system using a femtosecond pulse laser was used to measure the transmission amplitude and calculate the transmission attenuation rate.

The dynamic metasurface element was fixed to a sample holder having a diameter of 10 mm, and the transmission amplitude during the vertical incidence was measured. The number NA of the incidence openings of the terahertz beam incident on the dynamic metasurface element was about ⅙. Electromagnetic waves were incident on the dynamic metasurface elements of Example 2 and Example 4 from a direction perpendicular to the major axis direction of the line pattern.

An electrode for application was set to ground and the transmission amplitude was measured in a case where a voltage of 100 V was applied to the first patterned conductive layer of the dynamic metasurface element and in a case where no voltage was applied, and the transmission attenuation rate of the dynamic metasurface element (electromagnetic wave control element) with respect to electromagnetic waves of 0.28 THz in Example 1, 0.22 THz in Example 2, 0.31 THz in Example 3, 0.22 THz in Example 4, and 0.30 THz in Comparative Example 1 was calculated. The results are shown in Table 1.

The larger the difference between the transmission attenuation rate in a case where a voltage of 100 V is applied and the transmission attenuation rate in a case where no voltage is applied, the larger the amount of change in transmittance.

In the electromagnetic wave control elements of Example 2, Example 3, and Comparative Example 1, the second patterned conductive layer was used as it is as an electrode for application that ensures ground. In the electromagnetic wave control element of Example 4, the separately formed electrode for application was set to ground.

### <Measuring Method of Mobility of Graphene>

A graphene layer of a laminate consisting of the thermal tape, a coating film of polymethyl methacrylate (PMMA), and a graphene layer was attached to a surface of a SiO₂ layer of a p-doped silicon substrate (volume resistivity: 5 Ω·cm, thickness: 450 μm) having a thermal oxidized SiO₂ layer (thickness: 300 nm) on one surface, heated at 120° C., and the thermal tape was peeled off.

Next, the PMMA coating film of the laminate was removed with acetone, and a graphene layer was transferred onto the SiO₂ layer of the p-doped silicon substrate.

A resist pattern was formed on the surface of the graphene layer on the SiO₂ layer by a photolithography method, and the graphene was processed in a line shape by oxygen plasma ashing. Furthermore, after forming a resist pattern by using a photolithography method, Ni (thickness: 5 nm) and Au (thickness: 20 nm) were vapor-deposited and lifted off to form an electrode pattern, thereby producing a graphene electric field effect transistor element having a graphene channel with a width of 5 μm and a length of 50 μm.

The graphene electric field effect transistor element was set in a vacuum prober, heated at 200° C. for 24 hours under vacuum (6×10⁻³ Pa), and then cooled to 25° C.

Using a semiconductor parameter analyzer, Id-V_{g} characteristics were measured, and the mobility was calculated based on the following mathematical expression 1. Here, L represents a graphene channel length, W represents a channel width, Cₒₓ represents a capacitance of a SiO₂ layer, V_{d} represents a drain voltage, Id represents a drain current, and V_{g} represents a gate voltage.

$$μ = \frac{L}{{WV}_{d} {C}_{ox}} ( \frac{\partial {I}_{d}}{\partial {V}_{d}} )$$

The mobility of the graphene formed on the copper foil by the CVD method, which was used in Example 1, was 1,200 cm²/Vs. The mobility of the graphene formed on the epitaxial copper thin film by the CVD method, which was used in Examples 2, 3, and 4, was 4,000 cm²/Vs.

TABLE 1

| | First patterned conductive layer | | | Transmission | Transmission |
|---|---|---|---|---|---|
| | | Transmittance with | Second patterned | attenuation rate in case | attenuation rate in case |
| | | respect to electromagnetic | conductive layer | where no voltage is | where voltage of 100 V |
| | Type of patterning | wave of 0.3 THz | Type of patterning | applied (dB) | is applied (dB) |
| Example 1 | Linear structure | −1.0 dB | Linear opening portion | −10.1 | −19.1 |
| Example 2 | Linear structure | −1.0 dB | Linear opening portion | −10.6 | −26.3 |
| Example 3 | Linear opening portion | −2.2 dB | Linear opening portion | −12.9 | −21.8 |
| Example 4 | Linear structure | −1.0 dB | — | −4.8 | −10.3 |
| Comparative | No patterning | ∞ | Linear opening portion | ∞ | ∞ |
| Example 1 | | | | | |

As is clear from Table 1, it is found that the dynamic metasurface element of Examples having the first patterned conductive layer can control the transmittance at at least some wavelengths of electromagnetic waves by using an easy method of applying a voltage, as compared with the dynamic metasurface element (comprising a conductive layer not patterned) not having the first patterned conductive layer.

The entire disclosure of Japanese Patent Application No. 2022-088993, filed May 31, 2022, is incorporated into the present specification by reference. In addition, all documents, patent applications, and technical standards described in the present specification are incorporated herein by references to the same extent as the incorporation of the individual documents, patent applications, and technical standards by references are described specifically and individually.

What is claimed is:

1. An electromagnetic wave control element comprising:
a first patterned conductive layer;
an insulating layer; and
a layer containing a material of which conductivity changes with a voltage.

2. The electromagnetic wave control element according to claim 1, further comprising:
a second patterned conductive layer on a side of the layer containing the material of which the conductivity changes with the voltage, opposite to a side on which the insulating layer is provided.

3. The electromagnetic wave control element according to claim 1,
wherein a minimum value of a transmission attenuation rate of the first patterned conductive layer with respect to electromagnetic waves of 0.2 THz to 0.4 THz is −5.0 dB or more.

4. The electromagnetic wave control element according to claim 1,
wherein the first patterned conductive layer includes two or more linear structures or linear opening portions.

5. The electromagnetic wave control element according to claim 4,
wherein a shortest distance between the adjacent linear structures or between the adjacent linear opening portions is 1,000 μm or less.

6. The electromagnetic wave control element according to claim 1,
wherein the material of which the conductivity changes with the voltage includes a two-dimensional material.

7. The electromagnetic wave control element according to claim 6,
wherein the two-dimensional material has carbon.

8. The electromagnetic wave control element according to claim 1, wherein the material of which the conductivity changes with the voltage contains graphene.

9. The electromagnetic wave control element according to claim 1,
wherein the material of which the conductivity changes with the voltage includes a material having a band gap of 3.0 eV or more.

10. The electromagnetic wave control element according to claim 1,
wherein the material of which the conductivity changes with the voltage includes an oxide semiconductor.

11. The electromagnetic wave control element according to claim 10,
wherein the oxide semiconductor has at least one selected from the group consisting of In and Zn.

12. The electromagnetic wave control element according to claim 1,
wherein the first patterned conductive layer contains a metal or an oxide conductor.

13. The electromagnetic wave control element according to claim 2,
wherein the second patterned conductive layer contains a metal or an oxide conductor.

14. The electromagnetic wave control element according to claim 1,
wherein the first patterned conductive layer includes a metal wire or an oxide conductor wire.

15. The electromagnetic wave control element according to claim 2,
wherein the second patterned conductive layer includes a metal wire or an oxide conductor wire.

16. The electromagnetic wave control element according to claim 1, further comprising:
a substrate on a side of the first patterned conductive layer opposite to a side on which the insulating layer is provided.

17. The electromagnetic wave control element according to claim 16,
wherein a dielectric loss tangent of the substrate at a frequency of 28 GHz is 0.05 or less.

18. The electromagnetic wave control element according to claim 16,
wherein a transmittance of light having a wavelength of 550 nm of the substrate is 5% or more.

19. The electromagnetic wave control element according to claim 16,
wherein the substrate contains at least one selected from the group consisting of an inorganic compound and a resin.

20. A manufacturing method of an electromagnetic wave control element, the manufacturing method comprising:
a step of forming a first patterned conductive layer on a substrate;
a step of forming an insulating layer on the first patterned conductive layer; and
a step of forming a layer containing a material of which conductivity changes with a voltage on the insulating layer.
